(19) United States
(12) Patent Application Publication
(10) Pub. No.: US 2010/0103943 A1
(43) Pub. Date: Apr. 29, 2010

(54) METHODS AND APPARATUS TO PROVIDE POWER OVER AN ETHERNET-BASED NETWORK TO A WIDE AREA NETWORK ACCESS DEVICE

(76) Inventor: Edward Walter, Boerne, TX (US)

Correspondence Address: AT&T Legal Department - HFZ;ATTN. Patent Docketing, One AT&T Way, Room 2A-207, Bedminstor, NJ, 07921, US

(21) Appl. No.: 12/260,798

(22) Filed: Oct. 29, 2008

(51) Int. Cl. H04L 12/56

(52) U.S. Cl. 370/401; 370/419

(57) ABSTRACT

Methods and apparatus to provide power over an Ethernet-based network to a wide area network access device are described. In some example systems, a local area network (LAN) access point is configured to provide power to a gateway device, such as an optical network termination (ONT), via a wired Ethernet connection. The example LAN access points provide power via a wide area network (WAN) Ethernet port, through which the LAN access points receive WAN access from a gateway. The example gateway provides WAN access to a LAN access point, and receives power sufficient to operate the gateway via an Ethernet port. The example gateway also includes a WAN port, such as a fiber connection, through which the gateway connects to a service provider. The example systems allow a gateway to be powered without a traditional dedicated power connection.

### FIELD OF THE DISCLOSURE

This disclosure relates generally to network access systems and, more particularly, to methods and apparatus to provide power to a wide area network access device over an Ethernet-based network.

### BACKGROUND

Passive optical networks (PONs) are point-to-multipoint networks utilizing fiber optic transmission lines. A PON subscriber is provided with an optical network termination (or optical network terminal, ONT), which connects the subscriber's local network to an optical line termination (OLT). An OLT may connect many ONTs to the Internet or other wide area network via a central office.

The ONTs used in a passive optical network are generally kept outside of a subscriber's home or dwelling on, for example, an outer wall. The ONT is connected to the OLT via a fiber optic cable, and is also connected to a distribution point within the subscriber's home, such as a network switch or router, to provide devices in the home with wide area network access. The ONT also requires power, which is provided by an AC adapter that is plugged into a wall outlet. The AC adapter can often place constraints on the location of the ONT and may prevent placing of the ONT in an optimal location.

### BRIEF DESCRIPTION OF THE DRAWINGS

FIG. 1 illustrates an example passive optical network.

FIG. 2 illustrates an example single family unit configured as a passive optical network subscriber.

FIG. 3 is a block diagram of an example local area network access point to provide power over an Ethernet-based network to a wide area network gateway device.

FIG. 4 is a block diagram of an example gateway device to provide wide area network access to a local area network access point.

FIG. 5 is a block diagram of an example optical network termination to provide wide area network access to a local area network access point.

### DETAILED DESCRIPTION

The example systems and apparatus described herein are useful to provide power to wide area network access devices without the use of a separate power adapter. In some example systems, a local area network (LAN) access point provides LAN access to one or more devices via wireless and/or wired connections. The example LAN access point receives wide area network (WAN) access from a gateway device, such as an optical network termination (ONT), which is connected to a passive optical network (PON). In contrast to typical Power over Ethernet (PoE) systems, in which the access device provides power and WAN access to a client device, an example ONT described herein receives power from the LAN access point and provides WAN access to the LAN access point. As a result, the example ONT described herein requires fewer cables and has a reduced risk of malfunction in comparison to known systems.

The example gateway devices described below include a WAN access port to connect to a WAN provider. Some example ONTs connect to a PON central office via an optical line termination (OLT) for Internet access. The example ONTs described herein further include an Ethernet port, which provides a data link from the ONT to a LAN access device via an Ethernet cable, and receives power from the LAN access device via the Ethernet port. A power decoupler is further included to decouple the power received at the Ethernet port from the data link, and to provide the power received over the Ethernet port to other devices in the ONT. Such devices may include a processor configured to convert the optical signals from the PON to be conveyed via Ethernet and from Ethernet protocol to signals that can be conveyed via the PON.

Some example network access points described below include one or more LAN ports, such as Ethernet ports, to provide LAN and WAN access to client devices via wired communication links. The example network access points also include wireless access ports to provide LAN and WAN access to client devices via wireless communication links. To receive WAN access, the example network access points are provided with a WAN port, which may be coupled to an ONT or other gateway device via a data link. The WAN port may be coupled to the ONT or gateway device via an Ethernet cable, and the WAN port is configured to provide power to the gateway device via the Ethernet cable. Power may be provided to the network access point via, for example, a standard 120 volt alternating current (AC) adapter. The network access device converts the provided AC power to direct current (DC) power, and the DC power is coupled to the Ethernet data link via a coupling device.

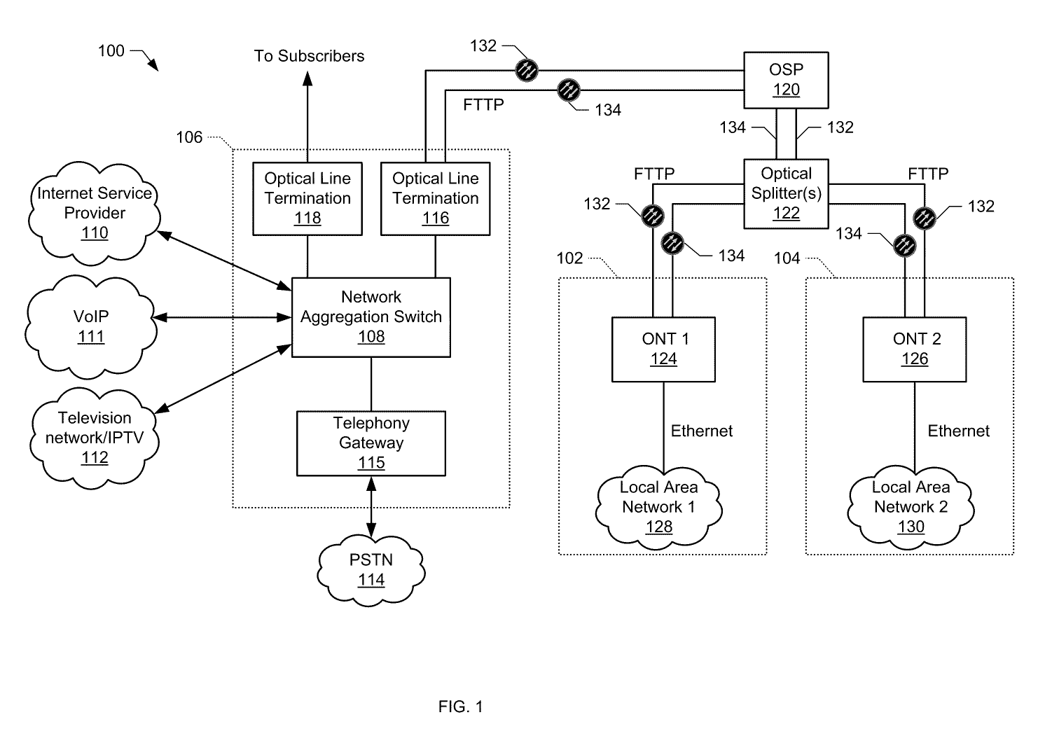

FIG. 1 illustrates an example PON 100. The PON 100 provides subscribers with communications services such as Internet, television, phone, and/or other multimedia or data services, via a fiber optic network. Subscribers, located in single family units such as the example single family units 102 and 104, connect to a central office (CO) 106 according to a service agreement. The service agreement may specify one or more types of service, a minimum performance level of service, a price for services, and/or any other relevant contractual service information. For example, the first single family unit 102 may have a service agreement to receive telephone and Internet services, and the second single family unit 104 may have a service agreement to receive “triple-play” services, which include telephone, Internet, and television services. In some examples, television services may be provided via Internet protocol television (IPTV). To provide multiple subscribers with high-bandwidth services, the PON 100 may be implemented as a broadband PON (BPON) or gigabit PON (GPON).

The example CO 106 generally acts as a distribution intermediary between media and/or service providers and a customer. For example, the CO 106 provides the single family units 102 and 104 with Internet service, television content, and/or telephone service. Telephone service may include either or both of plain old telephone service (POTS) format or Voice over IP (VoIP). A network aggregation switch 108 receives content to be delivered to the single family units 102 and/or 104 from one or more of an Internet service provider (ISP) 110, a VoIP system 111, a television network and/or IPTV provider 112, and/or a telephone network 114. The network aggregation switch 108 does not process voice data in POTS format. Thus, the example CO 106 may further include a telephony gateway 115 to convert voice data between POTS format and a digital format, such as VoIP. The techniques for network aggregation and VoIP to telephony conversion are well known and, thus, are not discussed further herein.

The network aggregation switch 108 distributes the appropriate media services to customer premises via OLTs 116 and 118. Each of the OLTs 116 and 118 broadcast optical signals via a point-to-multipoint connection to deliver the media services to customers. The example OLT 116 services the example single family units 102 and 104, and the example OLT 118 may service several other subscribers or customer premises.

To deliver services to the single family unit 102, the OLT 116 broadcasts optical signals to multiple single family units via outside plant (OSP) 120 and one or more optical splitters 122. OSP 120 includes the substantially stationary equipment used to transmit signals between the CO 106 and customer premises, such as the single family units 102 and 104. The OSP 120 includes, but is not limited to, cables, conduits, ducts, poles, towers, repeaters, and any other such equipment located outdoors. The OSP 120 may further include one or more optical splitters 122, which split the optical transmission along one fiber from the OLT 116 to multiple single family units 102 and 104. The example optical splitter 122 is unpowered.

The example CO 106, the OSP 120, the optical splitter 122, and the single family units 102 and 104 are configured in a fiber-to-the-premises (FTTP) network architecture. In an FTTP architecture, fiber cabling replaces traditional copper wire from the CO 106 to the customer premises, where an ONT receives data over the fiber connection and converts the data to another format. An FTTP architecture may encompass several lengths of fiber loop, including fiber-to-the-building (FTTB) and/or fiber-to-the-home (FTTH) configurations. The example single family units 102 and 104 each include an ONT 124 and 126, respectively. The example ONT 124 in the single family unit 102 converts data received over the fiber cable to a format useful on an Ethernet-based LAN 128. Similarly, the example ONT 126 in the single family unit 104 converts data to a format useful on an Ethernet-based LAN 130.

In point-to-multipoint architectures, the OLT 116 transmits data intended for one ONT, such as the ONT 124, and all connected ONTs 124 and 126 receive the data on a downlink channel 132. To prevent eavesdropping on the downlink channel 132, the OLT 116 may encrypt transmissions so only the intended ONT 124, and not unintended ONTs 126, may process and use the data. To control transmissions over an uplink channel 134, the example ONTs 124 and 126 share access to the uplink channel 134 based on time-division multiplexing. However, other methods to control access to the uplink channel 134, such as wavelength division multiplexing, may be implemented to enable multiple access to the uplink channel 134. The example downlink channel 132 and the uplink channel 134 are implemented using separate fiber cables.

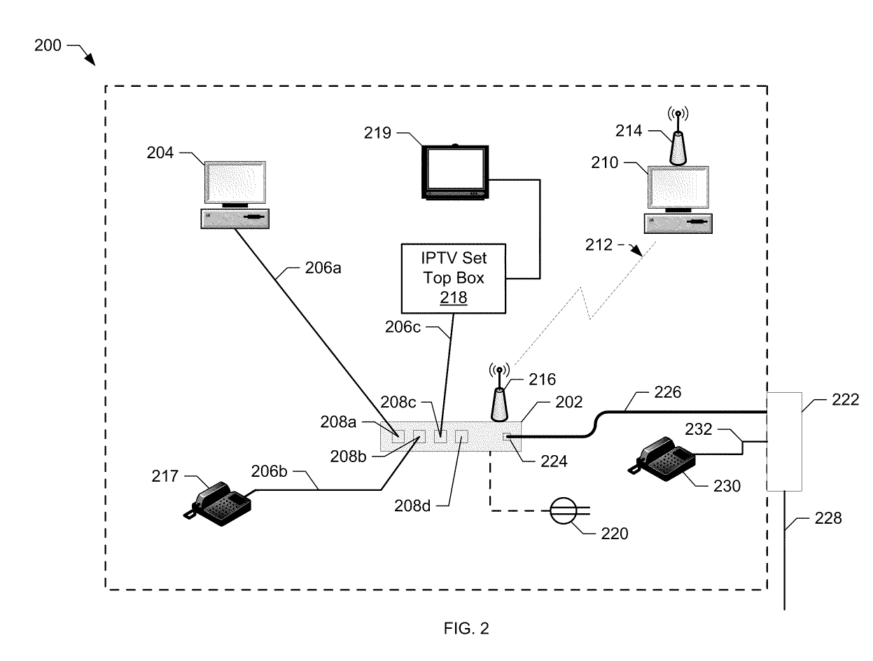

FIG. 2 illustrates an example single family unit 200 configured as a PON subscriber. The example single family unit 200 subscribes to communication services such as Internet, IPTV, television, VoIP, and/or POTS according to a subscriber contract. The example single family unit 200 is configured with a LAN that receives WAN access via the PON. The single family unit 200 may be an apartment, condominium, townhouse, single-family house, or any other type of dwelling in which one or more people may have temporary or permanent residence. However, the example systems may also be applied to commercial or industrial buildings.

A network access device 202 provides the example single family unit 200 with a LAN, to which other devices may connect via wired and/or wireless connections. The example network access device 202 is located within the single family unit 200. A personal computer 204 is connected to the example network access device 202 via a wired connection 206a. Typical wired connections 206 include CATS or CAT6 Ethernet cables. The wired connection 206a is coupled to the network access device via a LAN port 208a. The network access device 202 may include any number of additional LAN ports 208b-d to accommodate additional devices via additional wired connections. The personal computer 204 receives LAN access from the network access device 202, which enables the personal computer 204 to access shared network resources. The personal computer 204 further receives WAN access via the network access device 202 as described below.

A second personal computer 210, such as a notebook computer, connects to the example network access device 202 via a wireless connection 212. To this end, the personal computer 210 includes a transmitter/receiver or transceiver 214. The transceiver 214 may be implemented using a WiFi adapter, a Bluetooth adapter, or any other device to enable wireless communication between the personal computer 210 and the network access device 202. The transceiver 214 communicates with a similarly enabled transceiver 216 operatively coupled to the network access device 202. The transceiver 216 enables the network access device 202 to communicate wirelessly with any number of wireless-enabled devices. In some example implementations, the transceiver 216 includes multiple antennas to increase data throughput to one or more wirelessly-coupled devices.

An internet protocol (IP)-based telephone 217 may also be connected to the LAN via the LAN port 208b. The telephone 217 may make and receive phone calls via the WAN access provided by the LAN. Some example IP-based telephones 217, which are also referred to as VoIP phones, are connected to the network access device 202 via an Ethernet connection 206b. Additionally, some example IP-based telephones 217 may be powered via the Ethernet connection 206b.

The example network access device 202 may also communicatively couple to an IPTV set top box (STB) 218 to provide television programming and/or on-demand programming to users via a television set 219. The example IPTV STB 218 may be coupled to the LAN port 208c via an Ethernet connection 206c. The example IPTV STB 218 provides IPTV service that may include standard definition television (SDTV) content, high definition television (HDTV) content, premium channel content, on-demand movies and/or programs, digital television guides, digital video recording (DVR), or any other Internet protocol services that may be delivered to one or more users via the television set 219.

The network access device 202 receives power via a power coupling 220. In North America, the example power coupling 220 may be the standardized National Electrical Manufacturers Association (NEMA) 1-15 connector, which is rated for 110-120 volts of alternating current (VAC) at 60 hertz. However, many other connectors are widely used in various countries at other voltages and frequencies. The power coupling 220 conveys electrical power to circuitry within the example network access device 202.

The example single family unit 200 further includes a gateway 222, which may be physically located outside the single family unit 200. The gateway 222 may correspond to the example ONT 124 described in connection with FIG. 1. The gateway 222 provides WAN access to the single family unit 200 via a PON such as the PON 100 described in FIG. 1. The example gateway 222 is coupled to a WAN port 224 of the network access device 202 via a wired connection 226 such as a category 6 (CAT6) Ethernet cable.

In contrast to previous ONT devices or other WAN gateways, the example gateway 222 does not require a separate power terminal to provide power to the gateway 222. Instead, the example gateway 222 receives power from the network access device 202 via the CAT6 wired connection 226. Due to the physical location of the gateway 222, such as on an outside wall of the single family unit 200, the reduced number of physical connections reduces the number of potential equipment faults due to weather exposure or other outdoor hazards. An exemplary method for providing power from the network access device 202 to the gateway 222 via the CAT6 wired connection 226 is described in the IEEE 802.3 “Power over Ethernet” standards. One example implementation allows the network access device 202 to provide approximately 12.95 watts (W) of power to the gateway 222. However, according to the standard the network access device 202 may provide up to 15.4 W of power based on the length of the connecting CATS or CAT6 cable. In another example implementation, the network access device 202 may provide up to approximately 24 W of power to the gateway 222.

The example gateway 222 further includes a PON port, through which the gateway 222 communicates with the example CO 106 described in FIG. 1 via the example OSP 120 described in FIG. 1 via a fiber optic connection 228. The fiber optic connection 228 may correspond to the example downlink channel 132 and the uplink channel 134 illustrated in FIG. 1. The gateway 222 transmits and receives data over the WAN based on requests from devices connected to the LAN.

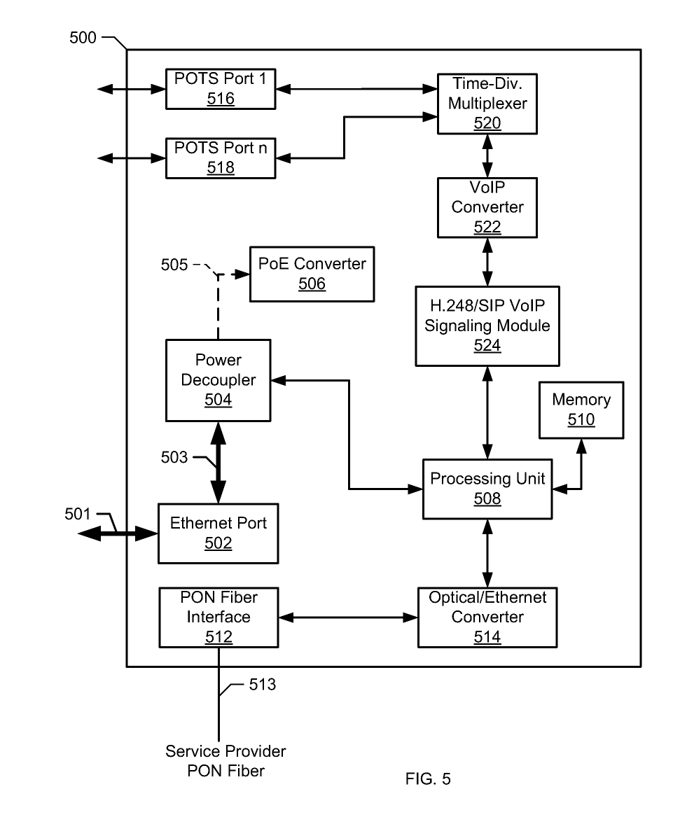

The example single family unit 200 may include one or more POTS telephone 230. The example POTS telephone 230 may receive telephone service via the gateway 222 and the fiber optic connection 228. An analog phone connection 232 connects the example POTS telephone 230 to a POTS port as described below in connection with FIG. 5.

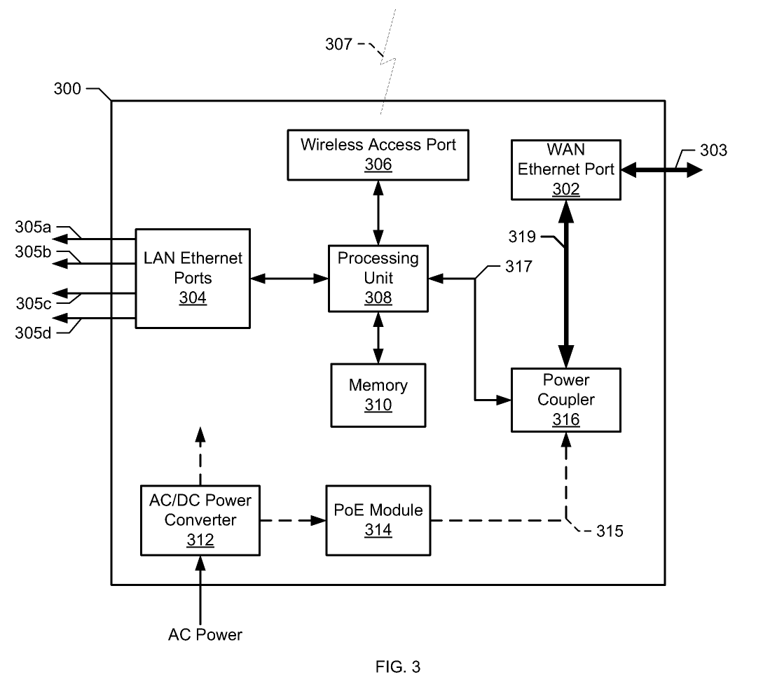

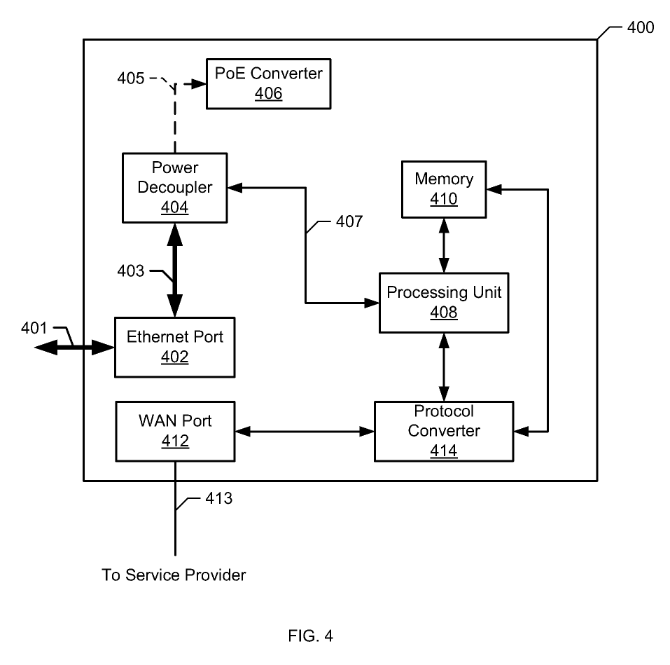

FIG. 3 is a block diagram of an example LAN access point 300 equipped to provide power over an Ethernet-based network to a WAN gateway device. The example LAN access point 300 may be used to implement the example network access device 202 illustrated in FIG. 2. In the illustrated example, the LAN access point 300 transmits and receives data to a service provider via a gateway, such as the gateway 222 illustrated in FIG. 2 and/or the gateway device 400 illustrated in FIG. 4, via a wired Ethernet link. The example LAN access point 300 further provides power to the gateway device over the Ethernet link. The WAN connection received by the LAN access point 300 is shared with any client devices connected to the LAN via one or more wired or wireless connections.

To communicate with a gateway device, the example LAN access point 300 is provided with a WAN Ethernet port 302. The WAN Ethernet port 302 communicatively couples the LAN access point 300 to a gateway device such as the device 222 of FIG. 2 via an Ethernet connection 303. In some examples, the WAN Ethernet port 302 includes a PoE-capable RJ-45 Ethernet connector, which includes PoE magnetic devices in the connector housing. In some other examples, the WAN Ethernet port 302 may be implemented using a discrete RJ-45 Ethernet connector in combination with discrete PoE magnetic devices. PoE magnetic devices typically include two center-tapped transformers, where each of the center taps functions as a terminal into which DC power is injected for transmission over an Ethernet connection.

To communicate with local client devices over the LAN, the example LAN access point 300 includes LAN Ethernet ports 304. The LAN Ethernet ports 304 communicatively couple each connected device to the LAN access point 300 and, as a result, to each of the other connected devices. The clients also receive WAN access via the LAN access point 300 via the WAN Ethernet port 302. Each device connects to the LAN Ethernet ports 304 via an Ethernet connection 305a, 305b, 305c, or 305d. Although the example LAN access point 300 shows four Ethernet connections 305a-305d, any number of Ethernet connections 305 may be used to serve a corresponding number of LAN Ethernet ports 304.

Local devices on the LAN may also connect to the LAN access point 300 wirelessly to a wireless access port 306 via one or more wireless connections 307. Any devices communicatively coupled to the wireless access port 306 may also be communicatively coupled to the other devices on the LAN, and such devices may further receive WAN access via the WAN Ethernet port 302.

The example LAN access point 300 further includes a processing unit 308 to provide WAN access from the WAN Ethernet port to devices connected to the LAN via the LAN Ethernet ports 304 and the wireless access port 306. The processing unit 308 also facilitates connections to the LAN, facilitates connections between LAN devices via the LAN, and routes data between connected devices. In some examples, the processing unit 308 encrypts and decrypts data for transmission, manages other security features, logs data requests, manages wireless connection power and speed, controls access to the wireless access port 306, and/or any other LAN access point, router, or network switch features.

The processing unit 308 further interacts with a memory 310. The memory 310 assists the processing unit 308 by temporarily or permanently storing data, storing logs, or storing settings, software, code, or instructions used by the processing unit 308. The example memory 310 may be any one or combination of volatile or non-volatile memory.

The example LAN access point 300 of FIG. 3 further includes an AC/DC power converter 312 to provide power to the components of the LAN access point 300. As described below, the AC/DC power converter 312 also provides sufficient power to power a gateway device coupled to the LAN access point 300. The AC/DC power converter 312 receives AC power via an AC connection. For example, a standard power connector may convey 120VAC, 60 Hz power from a standard North American wall outlet. In some examples, the AC/DC power conversion module 312 is located external to the LAN access point 300 and provides direct current (DC) power to a DC/DC power conversion module, which converts the received power to a desired voltage, such as 12 volts DC (VDC).

In the illustrated example, the AC/DC power converter 312 provides DC power to circuits in the LAN access point 300 such as, but not limited to, the wireless access port 306, the processing unit 308, the memory 310, and a PoE module 314.

The example LAN access point 300 further includes the PoE module 314 to provide power to an external gateway device, such as the device 222 of FIG. 2, via the Ethernet connection 303. The example PoE module 314 receives DC power from the AC/DC power converter 312, converts the power to a voltage compliant with PoE standards, and sends the power to a power coupler 316 via a power connection 315. The example power coupler 316 also has a data connection or link 317 to the processing unit 308. Data conveyed via the data connection or link 317 is combined with power conveyed via the power connection 315 at the power coupler 316 for transmission to the WAN Ethernet port 302 via a combined connection 319. The power coupler 316 also decouples data received via the combined connection 319 for transmission to the processing unit 308.

Ethernet cables typically include four pairs of twisted wires, for a total of eight wires. In some implementations of an Ethernet network, only two of the four pairs of wires are used for communications, leaving two spare pairs. In these Ethernet network implementations, the PoE module 314 may be configured to convey power via the spare pairs of wires. Thus, in such configurations, the power is not conveyed on the same pairs on which data is conveyed and, as a result, the power and data connections do not need to be coupled to or decoupled from the same pairs of wires. In these configurations, the data connection 317 may bypass the power coupler 316 and couple directly to the WAN Ethernet port 302.

The example PoE module 314 is implemented according to the IEEE 802.3 standards for power sourcing equipment (PSEs), which can be found on the IEEE web site. However, more power may potentially be achieved by not following the IEEE 802.3 standards.

Although not shown in the illustrated example, the WAN Ethernet port 302 and the LAN Ethernet ports 304 further include one or more Ethernet PHY chips. The PHY chips transform data from the Ethernet physical layer to a physical layer used by the processing unit 308, or any intermediate circuits. For example, the PHY chip may transform the differential signals received over the Ethernet connection 305a to a serial connection for transmission over a bus to the processing unit 308.

FIG. 4 is a block diagram of an example gateway device 400 to provide WAN access to a LAN access point. The example gateway device 400 may be used to implement the example ONTs 124 and/or 126 of FIG. 1, and/or the example gateway 222 illustrated in FIG. 2. The gateway device 400 may be located indoors or outdoors, and includes an Ethernet connection 401 to a LAN access point within a single family unit or other type of building. In contrast to conventional gateways, which require a power connection in addition to an Ethernet connection to provide power to the gateway devices, the example gateway device 400 receives sufficient power from the LAN access point via the Ethernet connection 401. However, the LAN access point must be properly equipped to provide power to the gateway device 400 via the Ethernet connection 401. The example LAN access point 300 illustrated in FIG. 3 is capable of providing sufficient power via an Ethernet connection to the example gateway device 400. However, other types of LAN access points 300, such as only wireless access points or wired routers, may be similarly equipped to provide power via an Ethernet connection and are hereby expressly included within the scope of this disclosure.

To connect to the example LAN access point 300 of FIG. 3, the example gateway device 400 includes an Ethernet port 402. The Ethernet port 402 is coupled to a LAN access point via the Ethernet connection 401, which provides a power and data connection therebetween. The Ethernet port 402 provides a power and data connection 403 to a power decoupler 404, which decouples power signals from data signals and routes the power signal(s) to a PoE converter 406 via a power connection 405. The example power decoupler 404 includes two center-tapped transformers, the center connections of which access power signal(s) via the Ethernet connection 401. The example PoE converter 406 converts the power from a high PoE voltage, such as 48 VDC, to a lower voltage to power the circuitry in the gateway device 400. The example power decoupler 404 further routes the data, which is decoupled from the power and data connection 403, to a processing unit 408 via a data connection 407, and couples data from the processing unit 408 destined for the LAN access point 300.

The example processing unit 408 manages data flowing between the LAN and the WAN. The processing unit 408 may manage known gateway functions such as network address translation, firewall protection and other security services, tunneling, event logging, and/or any other gateway and/or modem functions. The processing unit 408 further interacts with a memory 410, which may buffer data or messages, store configuration data, and/or other typical memory functions.

To access a WAN, the example gateway device 400 further includes a WAN port 412. The WAN port 412 is communicatively coupled to a service provider via a transmission medium, such as coaxial cable, fiber cable, terrestrial antenna, satellite dish, and/or other transmission media. The service provider may provide one or more types of media services, such as television, Internet, telephony, digital radio, video conferencing, and/or other media services. A protocol converter 414 converts the data received on the WAN port 412 to data and/or messages that may be processed by the processing unit 408, and converts messages from the processing unit 408 to a protocol suitable for transmission over the WAN port 412 to a service provider via a WAN interface 413. The protocol converter 414 may also bypass the processing unit 408 to send messages to the memory 410 to buffer messages for the processing unit 408.

FIG. 5 is a block diagram of an example ONT 500 to provide WAN access to a LAN access point. The example ONT 500 illustrated in FIG. 5 is connected to the LAN access point via an Ethernet connection 501 and receives power from the LAN access point via the Ethernet connection 501. The example ONT 500 is a powered device (PD) in terms of the PoE specification. The Ethernet connection 501, which is to carry data and DC power, is coupled to an Ethernet port 502. The Ethernet port 502 may be, for example, a PoE-enabled RJ-45 connector.

A power and data connection 503 couples the Ethernet port 502 to a power decoupler 504, which decouples DC power from the data received via the LAN access point. The DC power is sent via a power connection 505 to a PoE converter 506, which converts the 48V DC received over the Ethernet connection 501 to one or more desired voltages. The PoE converter 506 may be implemented using, for example, a DC/DC flyback converter. The DC voltage(s) generated by the PoE converter are used by the other circuits in the ONT 500.

The data decoupled at the power decoupler 504 is sent to a processing unit 508. The example processing unit 508 receives data from the power decoupler 504 and determines when to transmit the data over the PON. Similarly, the processing unit 508 determines whether data received over the PON is intended for the LAN access point or a device coupled thereto. The processing unit 508 further manages the ONT 500 operations, such as network address translation, firewall protection and other security services, tunneling, event logging, and/or any other gateway and/or modem functions.

The example processing unit 508 is further coupled to a memory device 510. The example memory device 510 may be implemented using one or more of volatile memory and/or non-volatile memory. The memory device 510 may store data for transmission by the processing unit 508, buffer data received from the PON, store system settings for the ONT 500, and/or any other desired storage tasks.

To communicate over the PON, the example ONT 500 includes a PON fiber interface 512. The PON fiber interface 512 is coupled to, for example, an OSP or a CO via a fiber connection 513. The PON fiber interface 512 receives optical signals via the fiber connection 513 and routes the signals to an optical/Ethernet Converter 514, which transforms optical signals to electrical Ethernet signals and transforms the electrical Ethernet signals to optical signals for transmission via the PON fiber interface 512. The optical/Ethernet converter 514 transmits electrical signals to the processing unit 508 for processing. Alternatively, the optical/Ethernet converter 514 may transmit the electrical signals to the memory 510 or a buffer, where the corresponding data may be stored for later processing.

The example ONT 500 may include one or more POTS ports 516 and 518. The POTS ports 516 and 518 permit one or more telephone lines to be routed via the PON network via, for example, VoIP protocols. The POTS ports 516 and 518 are routed to a time-division multiplexer 520, which routes the POTS signals from the POTS ports 516 and 518 to a VoIP converter 522 based on a time-sharing scheme. POTS signals are not bandwidth-intensive and, as a result, the VoIP converter 522 can convert several simultaneous phone calls on multiple POTS ports, thereby eliminating the need for multiple VoIP converters 522. The time-division multiplexer 520 may share the VoIP converter 522 conversion time between several POTS ports 516 and 518.

The VoIP converter 522 receives the POTS signals from the time-division multiplexer 520 and converts the signals to be compliant with VoIP application protocols. The VoIP converter 522 then sends the VoIP-based signals to an H.248/SIP VoIP signaling module 524, which generates the media gateway control signals. Messages and signaling are passed between the H.248/SIP VoIP signaling module 524 and the processing unit 508 during voice calls.

Although the example methods and apparatus described herein are discussed with reference to a passive optical network and an optical network termination, the described examples are equally applicable to any other device(s) that provide wide area network access to a local area network access device. Some examples include cable modems, digital subscriber line modems, satellite transceivers, wireless network transceivers, and/or any combination thereof. Additionally, although the IEEE PoE specification has adopted power limits over the Ethernet cable, the foregoing examples are not limited to complying with current or future PoE specifications. The IEEE PoE specifications include useful requirements to ensure safety and prevent damage to equipment.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A gateway device, comprising:
a wide area network port at a first location to connect to a second network location;
an Ethernet port to connect to a local area network device, wherein the Ethernet port is configured to receive power from the local area network device sufficient to provide power to circuitry within the gateway device and to provide a data link to the local area network device; and
a power decoupling device configured to decouple the power received from the local area network device from the Ethernet port.

2. A gateway device as defined in claim 1, wherein the second network location comprises an Internet service provider.

3. A gateway device as defined in claim 2, wherein the wide area network port is communicatively coupled to the Internet service provider via a passive optical network.

4. A gateway device as defined in claim 1, wherein the wide area network port comprises a passive optical network fiber interface.

5. A gateway device as defined in claim 1, further comprising a processing device configured to receive power via the power decoupling device.

6. A gateway device as defined in claim 1, further comprising a power over Ethernet converter to convert the power received from the Ethernet port at a first voltage to a second voltage.

7. A gateway device as defined in claim 1, wherein the gateway device consumes less than about 15.4 watts of power.

8. A gateway device as defined in claim 1, wherein the power decoupling device decouples the received power from wires on which the data link is provided to the local area network device.

9. A network access point, comprising:
a local area network port to provide a first data link to a first data client device via a wired connection;
a wide area network port to receive wide area network access via an Ethernet cable providing a second data link to a gateway device, and to provide power to the gateway device via the Ethernet cable; and
a power coupler to couple the power to the gateway device with the second data link for transmission via the Ethernet cable.

10. A network access point as defined in claim 9, wherein the local area network port provides the wide area network access to the first data client device via the first data link.

11. A network access point as defined in claim 9, further comprising a wireless access port configured to provide a second data link to a second data client device via a wireless connection.

12. A network access point as defined in claim 9, further comprising:
an AC/DC power converter configured to generate direct current at a first voltage based on an alternating current source; and
a power over Ethernet module to generate direct current at a second voltage for transmission over the Ethernet cable.

13. A network access point as defined in claim 12, wherein the power coupler couples the second data link to a first set of wires and couples the power to a second set of wires.

14. A network access point, comprising:
a wireless access port configured to provide a first data link to a first data client device via a wireless data connection;
a wide area network port configured to receive wide area network access via an Ethernet cable providing a second data link to a gateway device, and to provide power to the gateway device via the Ethernet cable; and
a power coupler to couple the power to the gateway device with the second data link for transmission over the Ethernet cable.

15. A network access point as defined in claim 14, wherein the wireless access port provides the wide area network access to the first data client device via the first data link.

16. A network access point as defined in claim 14, wherein the power coupler couples the second data link to a first set of wires and couples the power to a second set of wires.

17. A network access point as defined in claim 14, further comprising:
an AC/DC power converter configured to generate direct current at a first voltage based on an alternating current source; and
a power over Ethernet module to generate direct current at a second voltage for transmission over the Ethernet cable.

18. A system, comprising:
a network access point comprising:
a local area network port configured to provide a first data link to a first data client device via a wired connection;
a wide area network port configured to receive wide area network access via an Ethernet cable providing a second data link to a gateway device and configured to provide power to the gateway device via the Ethernet cable;
a coupling device to couple the power to the gateway device with the second data link for transmission over the Ethernet cable;
wherein the gateway device comprises:
a wide area network port at a first location to connect to a second network location;
an Ethernet port to connect to the wide area network port of the network access point via the Ethernet cable and configured to receive the power from the network access point sufficient to provide power to circuitry within the gateway device, and to provide the second data link to the network access point via the Ethernet cable; and
a power decoupling device, configured to decouple the power received from the network access point from the second data link.
